(19) United States
(12) Patent Application Publication
(10) Pub. No.: US 2014/0337714 A1
(43) Pub. Date: Nov. 13, 2014

(54) METHOD AND DEVICE FOR GENERATING A PERSONALIZED NAVIGATION WEBPAGE

(71) Applicant: Tencent Technology (Shenzhen) Company Limited, Shenzhen (CN)

(72) Inventor: Yikun Mu, Shenzhen (CN)

(21) Appl. No.: 14/340,918

(22) Filed: Jul. 25, 2014

Related U.S. Application Data
(63) Continuation of application No. PCT/CN2014/076041, filed on Apr. 23, 2014.

(30) Foreign Application Priority Data
May 13, 2013 (CN) CN 201310174131.7

(51) Int. Cl. G06F 17/30; G06F 17/22; H04L 29/08

(52) U.S. Cl. CPC G06F 17/30893; H04L 67/22; G06F 17/2247
USPC 715/234

(57) ABSTRACT

The present disclosure has disclosed a method, an apparatus, and a system of opening a web page and belongs to the technical field of the Internet. Said method comprises: A binding relationship among terminals stored in advance in a server; said server receives the web page information of a target web page sent by the first terminal; according to the binding relationship among terminals stored in advance, said server determines the second terminal, which has a binding relationship with said first terminal; according to the web page information of said target web page, said server sends a notice of web page information to said second terminal so that said second terminal opens said target web page according to said notice of web page information.

### CROSS-REFERENCES TO RELATED APPLICATIONS

This application claims priority to and is a continuation of PCT/CN2014/076041, filed on Apr. 23, 2014 and entitled “METHOD AND DEVICE FOR GENERATING A PERSONALIZED NAVIGATION WEBPAGE,” which claims the benefit of Chinese Patent Application No. 201310174131.7, filed on May 13, 2013, the contents of which are both incorporated by reference in their entireties.

### FIELD OF THE INVENTION

The disclosure is generally related to web browser and in particular is related to a method and device for generating a personalized navigation webpage.

### BACKGROUND OF THE INVENTION

Along with rapid developments in Internet technology, a web browser has become one of the most common tools for acquiring information in daily life and work. Via a web browser, a user may browse web pages, play video and audio, do online shopping, and perform other Internet operations.

### SUMMARY OF THE INVENTION

The purpose of the disclosure is to provide the method and device for generating a personalized navigation webpage, to realize the dynamic adjustments of the contents of a navigation webpage and to meet the requirement that the user can find interesting contents.

To reach the goal stated above, the disclosure provides the method for generating a personalized navigation webpage. The steps are stated below:

Acquire the categories of interest which have already existed and the behavior record of the user in a browser, and based on the categories of interest which have already existed and the behavior record of the user in a browser, the information of the user's interest is acquired; and/or acquire the characteristic information of the user's device;

The information which the user is interested in and/or the characteristic information of the user's device are analyzed;

Based on the result of the analysis, a matching is made, and then the navigation website generates a personalized navigation webpage in the browser.

A device proposed by the disclosure for generating the personalized navigation webpage includes an acquisition module configured to acquire already existing categories of interest and the behavior record of the user in a web browser, and based on the categories of interest which have already existed and the behavior record of the user in a browser, the information of the user's interest is acquired; and/or acquire the characteristic information of the user's device. Also included in the device is an analysis module configured to analyze the information of the user's interest and/or the characteristic information of the user's device. The device also includes a generation module that is configured to match the web sites with the categories and generates a personalized navigation web page in the web browser.

The disclosure provides the method and device for generating a personalized navigation webpage by detecting the behavior and interest of the user in the browser and considering other conditions of the user's browser (for instance, the characteristic information of a device: Internet connection of a portable terminal and service provider, and so on), the disclosure can send a feedback of the relevant data and information to the browser, and then the navigation webpage is generated. This is a dynamic method by using which the personalized navigation contents can be realized based on the interest of the user and the characteristic information of the user's device. And so the user's need of finding interesting contents can be satisfied.

### BRIEF DESCRIPTION OF THE DRAWINGS

FIG. 1 is a diagram of an example personalized navigation web page in an embodiment;

FIG. 2 is a diagram of a representative N-level hierarchical tree of categories of web sites that may be used to generate the example personalized navigation web page of FIG. 1;

FIG. 3 is a flow diagram of an example method for generating a personalized navigation web page;

FIG. 4 is a flow diagram of another example method for generating a personalized navigation web page;

FIG. 5 is a block diagram of an example device for generating a personalized navigation web page;

FIG. 6 is a block diagram of an example acquisition module that may be implemented in the example device of FIG. 5 for generating a personalized navigation web page;

FIG. 7 is a block diagram of another example device for generating a personalized navigation web page;

FIG. 8 is a block diagram of another example device for generating a personalized navigation webpage.

### DETAILED DESCRIPTION

Methods and devices for generating and dynamically adjusting a personalized navigation web page based on a user's changing interests are disclosed. Personalization and dynamic adjustment of the navigation web page is performed based on the user's prior web browsing history. Additionally, characteristics of the device on which the personalized navigation web page is displayed may be considered in generation of the personalized navigation web page. Also included in the process of personalization is the user's location, the type of network that the device is connected to, etc.

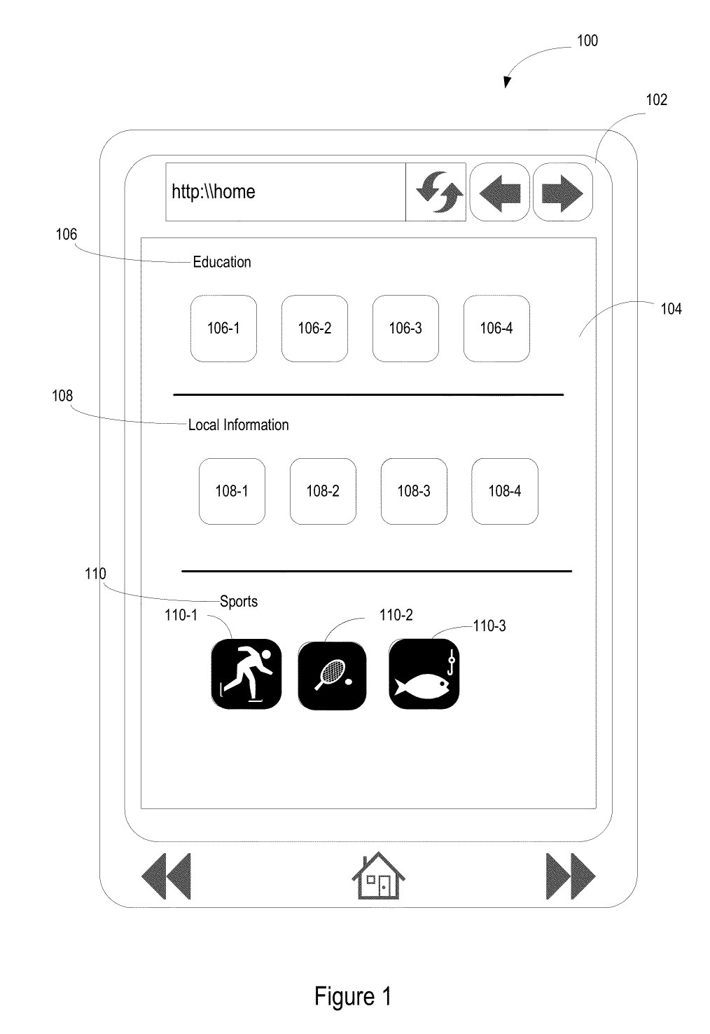

FIG. 1 illustrates an example personalized navigation web page 102 displayed in a web browser 102 of a device 100. Generally, a personalized navigation web page 102 comprises hypertext links or references to web sites and web pages where the references are tailored to the personal tastes and interests of a user. The personalized navigation web page 104 may be generated and dynamically adjusted by methods described herein. By way of example and without limitation, the personalized navigation web page 102 comprises several categories 106, 108 and 110. Each of the categories comprises several sub-categories. For example, category 106 comprises sub-categories 106-1, 106-2, 106-3 and 106-4, category 108 comprises sub-categories 108-1, 108-2, 108-3 and 108-4 and category 110 comprises sub-categories 110-1, 110-2, and 110-3. Information corresponding to the subcategories may be dynamically generated based on the browsing history of the user. The web browser history may correspond to web sites that were previously visited by a user using the web browser 102.

By way of example, in one embodiment, a subcategory may correspond to a reference to a destination web page that includes content for the corresponding category and subcategory. A reference may be a hyper link to the destination web page. For example, subcategory 110-3 may link to a webpage for fishing information. In another embodiment, a subcategory may link to another personalized navigation web page that includes further subcategories. For example, subcategory 110-2 may link to a personalized navigation web page that includes subcategories of racket sports, like tennis, badminton etc.

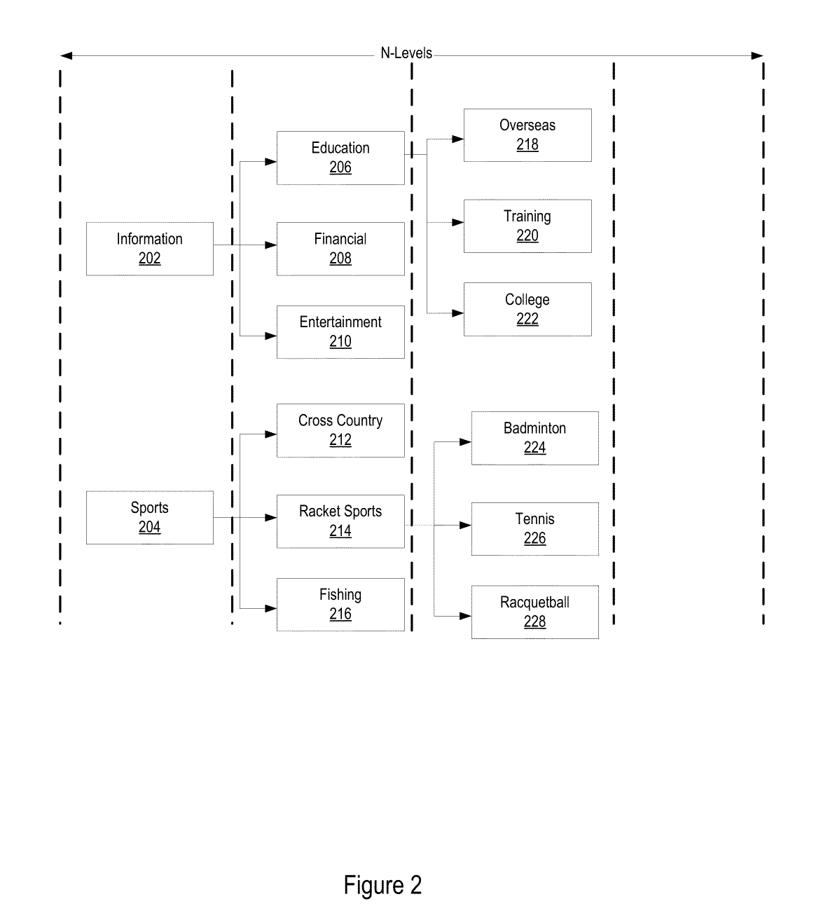

Referring to FIG. 2, methods described herein may generate a tree-like hierarchical structure 200 based on the classification of the types of web sites visited by the user using web browser 104 i.e. the web browsing history. The tree-like N-level hierarchical structure 200 has several nested categories and subcategories of interests. Methods described herein calculate a weight for each node in the tree-like hierarchical structure 200. The weight may correspond to the user's interest in on-line information related to the particular category/subcategory.

At each level, based on the analysis of webpages corresponding to a category, further subcategories may be determined. For example subcategory 214 includes further categories 224, 226 and 228. In some embodiments, the personalized navigation webpage 102 may include N-levels of categories corresponding to the hierarchical structure 200. For example, category 110 and sub-categories 110-1, 110-2, and 110-3 of FIG. 1 may correspond to category 204 and subcategory 212, 214 and 216 of FIG. 2. In embodiments described below a category and subcategory displayed on the personalized navigation webpage 102 may be removed or added based on the user's online behavior or interaction with websites classified as belonging to the category or subcategory.

In one embodiment, the web browser 104 may record user's behavior for a period of time. A user's behavior may include key words searched, web sites visited by the user using the web browser 104 including the PV of every domain name which is visited during the period of time, the time spent at each of the visited web sites and any other online activity performed by the user at each of the visited websites, for example buying a product, posting a comment etc.

In an embodiment, a textual analysis may be performed on the web pages of the web sites visited by the user i.e. the web browser history. The result of the analysis may be used to classify a web site into one of the existing categories of interest, for example 106, 108 and 110 (FIG. 1). In scenarios where a textual analysis cannot be performed on a web page or web site, the web page may be classified by the domain name or URL. In another embodiment, the result of the analysis may be used to generate new categories or subcategories of interests. In one embodiment, intention recognition may be performed on key words being searching, and the result of the intention recognition may be used to classify web sites visited into the categories of interest. For example, if a key word “soccer” is use to perform a search, a web site that a user visits that was a result of the key word search “soccer” may be classified in the category 110 of FIG. 1.

By way of example and without limitation, in an embodiment, web sites in each category may be weighted based on several criteria. An example of a weighting equation is described below.

$$\begin{matrix}{PV}_{A} > \overline{{PV}_{A}} , W = \frac{{PV}_{A}}{\sum {PV}_{all} categories} \times \sqrt{{PV}_{A} - \overline{{PV}_{A}}} \times {e}^{- nγ} & Equation 1 \\ {PV}_{A} < \overline{{PV}_{A}} , W = \frac{{PV}_{A}}{\sum {PV}_{all} categories} \times \frac{1}{\sqrt{\overline{{PV}_{A}} - {PV}_{A}}} \times {e}^{- nγ} & Equation 2\end{matrix}$$

PV_{A} is the number of page views for a category A. By way of example, PV_{A} may correspond to the number of page views for web pages that are classified as belonging to category 110 of FIG. 1. W, in the case of category 110, corresponds to the determined weight for all web pages categorized as belonging to category 110. ΣPVₐₗₗ categories corresponds to the sum of all the page views of web pages for all categories, in one embodiment. In another embodiment, referring to FIG. 2, ΣPVₐₗₗ categories, may correspond to the sum of the page views of web pages categorized as belonging to the corresponding level. For example, in this embodiment, when calculating the weight W for web sites categorized as belonging to category 214, PVₐₗₗ categories may correspond to the sum of page views of websites categorized as belonging to category 206, 208, 210, 212, 214 and 214. e^{-nγ} represents the exponential decay or attenuation in a user's interest or weight for web pages categorized or classified as category A. n corresponds to the elapsed time between when the weight W is computed and the time when the user last viewed or interacted with a web page classified as belonging to category A. Whenever a user views a web page the time n for the category A may be reset to zero. n may be represented in minutes, hours or days. The greater the elapsed time n, the less the value of weight W for web pages categorized as belonging to category A. γ is a decay constant that may be appropriately selected.

Generally the average value of the number of the users' page views of websites in every category is compared, and based on the result of the comparison, adding or subtraction is performed to generate a result. Finally, normalization processing is performed on the calculated result.

Referring to FIG. 2, a weight W may be calculated for each category of web sites at every level for each node in the tree-like hierarchical structure 200. For example, a weight may be calculated using equation 1 and 2 for all websites classified as category 204. Page views for all web sites categorized as 212, 214 and 216 may be utilized in calculating the weight for category 204. Separately, a weight may be calculated for web pages classified as belonging to subcategory 214. Further, a weight may be calculated for web pages classified as belonging to subcategories 224, 226 and 228 of subcategory 214. Based on the calculated weight for each subcategory, the subcategory may or may not be displayed on the personalized navigation web page 102. For example, over time if a user does not visit, view or interact with a web page whose content is classified as belonging to subcategory 214, subcategory 110-2 i.e. racket sports may be removed from the personalized navigation web page 102, in an embodiment.

Table 1 represents example weights calculated for the category 204 and two of its subcategories 214 and 216.

| | Category | | | | | |
|---|---|---|---|---|---|---|
| | | Racket | Bad- | | Racquet- | |
| | Sports | Sports | minton | Tennis | ball | Fishing |
| | 204 | 214 | 224 | 226 | 228 | 216 |
| Weight | 0.85 | 0.85 | 0.04 | 0.1 | 0.9 | 0 |

Based on the weights depicted Table 1, in this example, navigation web page 102 may be personalized to remove subcategory 110-3 of FIG. 1 for web pages related to fishing because the calculated weight for subcategory 216 is zero.

In one embodiment, the user's online behavior i.e. page views may be recorded for a period of time, example 30 days, before calculating weights for each category. In this embodiment, the personalized navigation web page 102 may be updated only when the weights for each category/subcategory are calculated. In another embodiment, weights for each category may be computed in real time. In this embodiment, personalization of the navigation web page 102 may occur continuously i.e. categories and subcategories may be dynamically added or removed in real-time.

In another embodiment, device information corresponding to the device 100 may be utilized to dynamically update and personalize the navigation web page 102. Device information may include intrinsic characteristics such as hardware, operating system software, extrinsic characteristics such as the type of network device 100 is connected to, LTE, 3G etc. and the geographic location of the device 100. GPS, wifimac (BSSID), CeLLID and IP and so on may be used together to acquire the geographical location of the device 100.

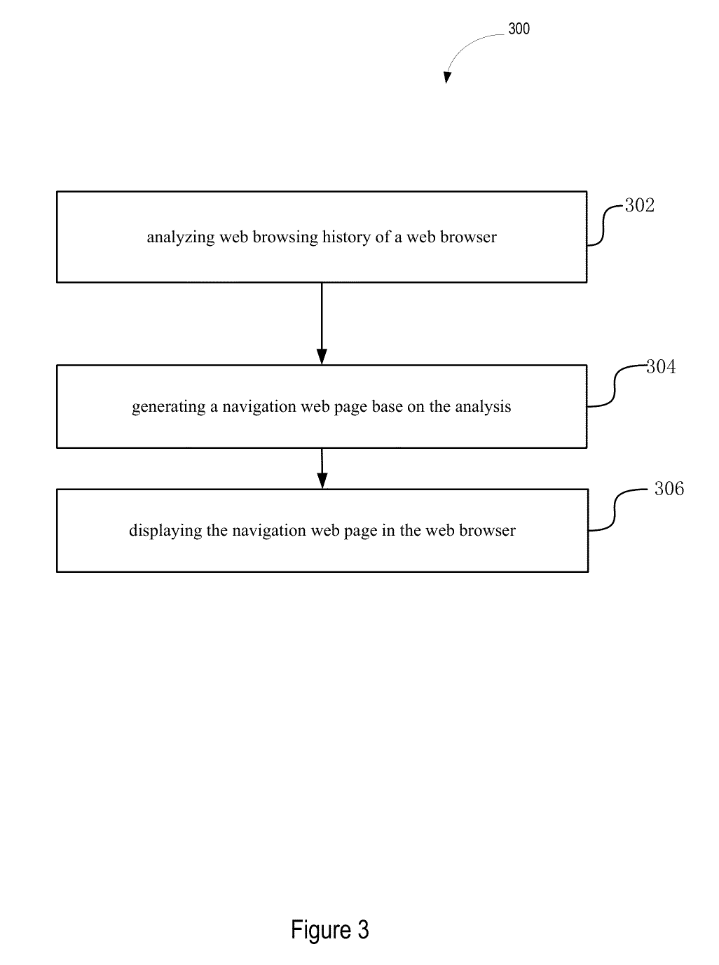

FIG. 3 is a flow diagram of an example method 300 for generating a personalized navigation webpage. Method 300 may be implemented in device 100 of FIG. 1, in an embodiment. Method 300 may be implemented in the web browser 102 of FIG. 1, in an embodiment. At step 302, web browsing history of the web browser 102 may be analyzed. As previously discussed the web browsing history may include references to web sites visited by the user using the web browser 102. Analyzing the web browsing history may include performing a textual analysis or image analysis of the content of each of the web sites referenced in the web browsing history.

In this step, the user's interest is determined based on the user's browsing history as reflected by visited webpages using web browser 104, in an embodiment. The user's preference can be calculated by analyzing the webpages visited by the user in the browser and the user's interest can be classified, for example, military affairs-aircraft carrier, technology-the Internet, shopping-female-winter clothing, and so on. Previously discussed method for the calculation of weights may be performed for every category of webpage or website.

At step 304, the information of the user's interest and/or the characteristic information of the user's device may be analyzed. At step 306, based on the analysis result, a navigation webpage which matches the user's interest and the characteristics of user's device 100 may be generated.

In this step, based on the information of the user's interest and the characteristics of the user's device, different methods may be used to generate a personalized navigation webpage. These methods include user specified, auto-matching and matching learning recommendation and so on, as long as the methods aim to provide a navigation webpage which is related to the information of the user and can be adjusted dynamically.

Thus, based on the user's interest, navigation webpages may be generated as specified by the user of the device, device 100 for example. For example, a user who is very interested in sports may specify the user's interest in sports. In one embodiment, a uniform resource locator (URL) of website “Tencent Sport” may be sent to device 100.

In the process of customizing the navigation webpage, it is possible that only one website corresponds to one category of the user's interest or that some websites correspond to only one category of the user's interest. That is to say, the relation between the websites on the navigation webpage and the categories of the user's interest is many to many.

For example, news contents may be provided on the personalized navigation page of 104 for a user interested in news. Similarly, video and audio contents are provided for video lovers in the navigation page 104. In addition, by analyzing the characteristic information of a user's device, the characteristics of user's device may be acquired. By considering the characteristics of user's device, websites to be presented on the navigation page may be selected.

For instance, video websites with mp4 videos are provided for device that is configured to execute the IOS, and video websites with flash videos are provided for Android users. Separately, local news contents are provided for users in Chengdu. Or a touch-screen version navigation webpage with soccer information is provided for a soccer lover who uses 3G. Meanwhile, in the same location of the navigation webpage, a navigation webpage with financial and stock news is provided for financial lovers who use 2G; or on the navigation webpage, the official website of China Unicorn can be seen for the users of China Unicorn, and the official website of China Mobile can be seen for the users of China Mobile. Users in Chengdu can see the category of “Hot News in Chengdu” and users in Guangdong can see the category of “The Weather of Guangdong” on the navigation webpage.

Through the scheme mentioned above, in the embodiment, the user's interest is classified, and through the visiting record and behavior in the browser, the user's interest is detected. Every category of the user's interest is given a weight value. Besides, by considering other conditions of the user's browser (such as the characteristic information of a device: the Internet connection of the portable terminal, service provider and geographical location and so on), the disclosure can send a feedback of the relevant data and information to the browser, and then a navigation webpage which matches the user's interest and characteristics of the user's device is generated.

This is a dynamic method by using which the personalized navigation contents can be generated based on the interest of the user and the characteristics of the user's device. And so different users and devices correspond to different navigation pages. Therefore, the user's need of finding interesting contents can be satisfied.

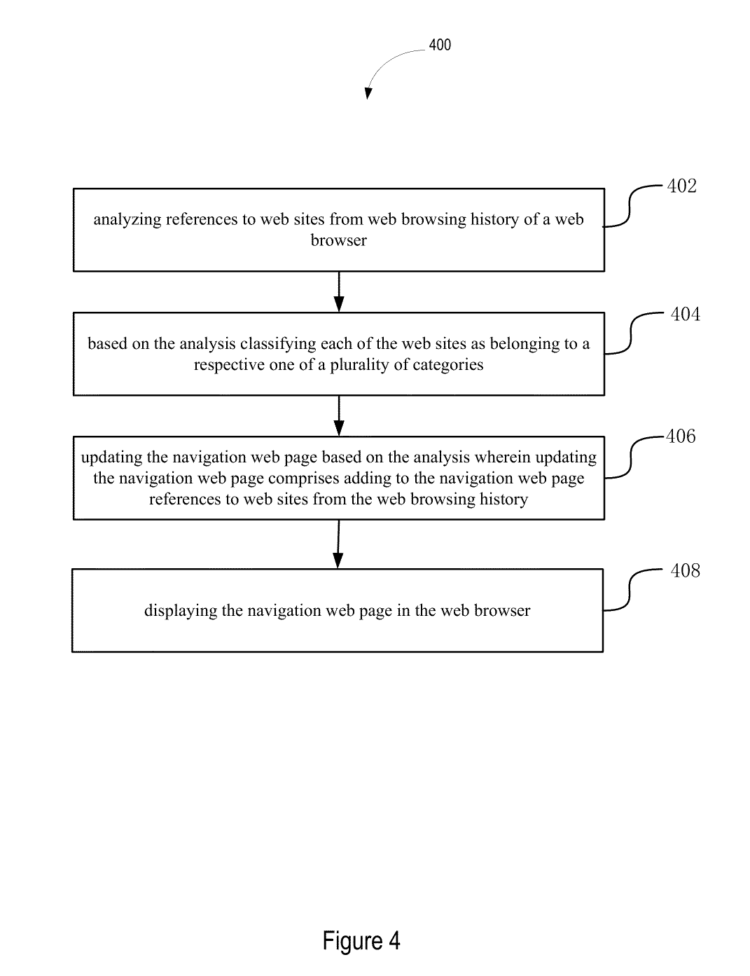

FIG. 4 is a flow diagram of yet another example method 400 for generating a personalized navigation webpage such as that illustrated in web browser 104 of FIG. 1. Method 400 may be implemented in device 100 of FIG. 1, in an embodiment. This method is may be based on the first embodiment of FIG. 3. Step 406, based on the new browsing behavior of the user in the web browser, the information of the user's interest and/or the characteristic information of the user's device the personalized navigation web page may be updated.

The difference between the method of FIG. 3 and FIG. 4 is that in the method of FIG. 4, the real-time update of the user's interest can be realized and based on the condition of the user's browsing behavior at a network terminal and the characteristic information of the user's device, such as geographical location of the network terminal, and so on, a dynamic adjustment on the personalized navigation webpage is made after the real-time update of relevant information.

For instance, with regard to a user who is interested in soccer, when the device switches from using 3G to a 2G network terminal, based on the browsing history of the user, the information of the user's interest is updated. And in the same position of the navigation page, a touch-screen version navigation webpage with soccer information is provided for the soccer lover.

Through the scheme mentioned above, in the embodiment, based on the real-time update of the user's interest and the characteristic information of the user's device, the disclosure can send a feedback of the relevant data and information to the browser, and then the navigation webpage is generated. This is a dynamic method by using which the personalized content navigation can be realized based on the interest of the user and the characteristic information of the user's device. And so the user's need of finding interesting contents can be satisfied.

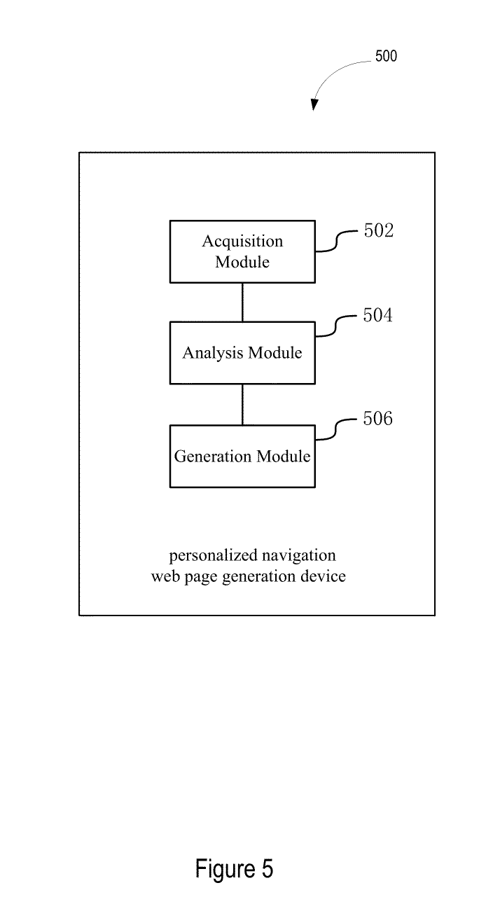

FIG. 5 is the block diagram of an example device 500 that may generate a personalized navigation webpage. The device 500 comprises the acquisition module 502, analysis module 504 and generation module 506, in one embodiment. In an embodiment, device 500 may correspond to a processor and memory that is configured to execute instructions corresponding to the method steps of flow diagram illustrated in FIGS. 3 and 4.

Acquisition module 502 is configured to acquire the categories of interest which have already exist in the web browser 102 and the behavior record of the user in the web browser 102, and based on the categories of interest which have already existed and the behavior record of the user in a browser, the information of the user's interest is acquired.

Analysis module 504 is configured to analyze the information of the user's interest and/or the characteristic information of the user's device. Generation module 506 is adapted to generate a personalized navigation webpage in the web browser 102.

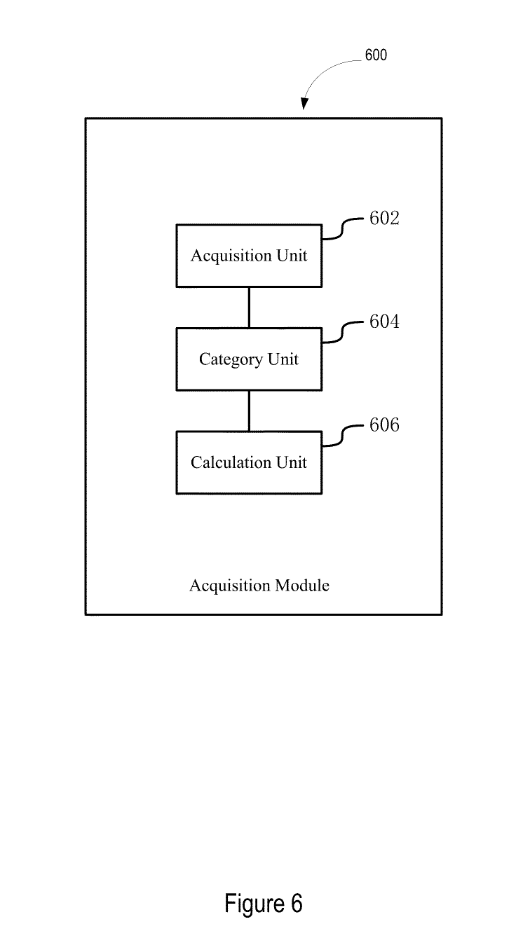

FIG. 6 is a block diagram of an acquisition module 502 in one embodiment. In the embodiment of FIG. 6, the acquisition module comprises an acquisition unit 602, a category unit 604, and calculation unit 606. Acquisition unit 602 may be configured to acquire the categories of interest which have already existed and the behavior record of the user in a browser. Category unit 604 may be configured to categorize web sites into already existing categories. As an example, category unit 604 may categorize the websites using a hierarchical tree structure such as described with reference to FIG. 2. Calculation unit 606 may be configured to perform calculation of the previously discussed weights for each of the categories.

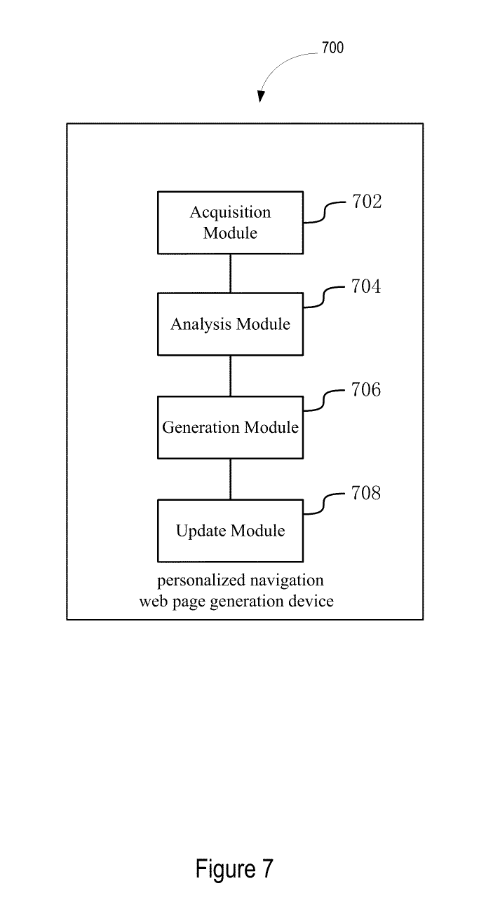

FIG. 7 is a block diagram of another example device 700 that may generate a personalized navigation webpage. The device 700 comprises acquisition module 702, analysis module 704, generation module 706, and update module 708, in one embodiment. In an embodiment, device 700 may correspond to a processor and memory that is configured to execute instructions corresponding to the method steps of flow diagram illustrated in FIGS. 3 and 4.

Acquisition module 702 is configured to acquire the categories of interest which have already exist in the web browser 102 and the behavior record of the user in the web browser 1-2, and based on the categories of interest which have already existed and the behavior record of the user in a browser, the information of the user's interest is acquired.

Analysis module 704 is configured to analyze the information of the user's interest and/or the characteristic information of the user's device. Generation module 706 is adapted to generate a personalized navigation webpage in the web browser 102.

Update module 708 is configured to provide the real-time update of the user's personalized navigation webpage based on the user's interest, based on the condition of the user's browsing behavior at a network terminal and the characteristic information of the user's device, such as geographical location of the network terminal. Based on the analysis of the aforementioned characteristics, the update module 708 produces a dynamic adjustment on the personalized navigation webpage after the real-time update of relevant information.

For instance, with regard to a user who is interested in soccer, when the device switches from using 3G to a 2G network terminal, based on the browsing history of the user, the information of the user's interest is updated. And in the same position of the navigation page, a touch-screen version navigation webpage with soccer information is provided for the soccer lover.

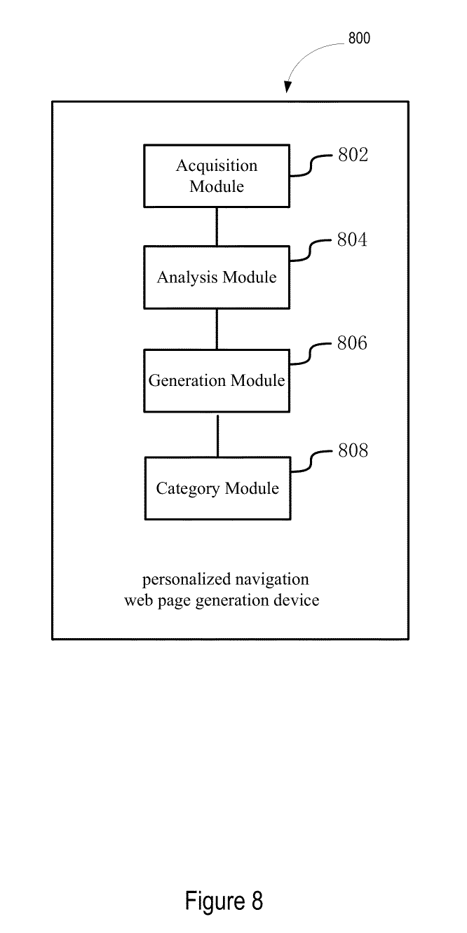

FIG. 8 is a block diagram of another example device 800 that may generate a personalized navigation webpage. The device 800 comprises acquisition module 802, analysis module 804, generation module 806, and category module 808, in one embodiment. In an embodiment, device 800 may correspond to a processor and memory that is configured to execute instructions corresponding to all or a combination of the method steps of flow diagrams illustrated in FIGS. 3 and 4.

Acquisition module 802 is configured to acquire the categories of interest which have already exist in the web browser 102 and the behavior record of the user in the web browser 102, and based on the categories of interest which have already existed and the behavior record of the user in a browser, the information of the user's interest is acquired.

Analysis module 804 is configured to analyze the information of the user's interest and/or the characteristic information of the user's device. Generation module 806 is adapted to generate a personalized navigation webpage in the web browser 102.

Category module 808 is configured to categorize the websites visited by the user using the web browser 102. By means of pre-classification, the categories of the already existing interest can be concluded. And these categories can serve as a reference for classification in the future.

Through the scheme mentioned above, in the embodiment, the user's interest is classified, and through the record of the web browsing behavior of the user, the user's interest is detected. Every category of the user's interest is given a weight value using previously described weighting techniques. Besides, by considering other conditions of the user's browser (such as the characteristic information of a device: the Internet connection of the portable terminal, service provider and geographical location and so on), the category module 808 can send a feedback of the relevant data and information to the web browser 102, and subsequently a personalized navigation webpage that matches the user's interest and characteristics of the user's device may be generated. This may be done dynamically and in real-time.

Through the scheme mentioned above, in the embodiment, based on the real-time update of the user's interest and the characteristic information of the user's device, the disclosure can send a feedback of the relevant data and information to the browser, and then the navigation webpage is generated. This is a dynamic method by using which the personalized content navigation can be realized based on the interest of the user and the characteristic information of the user's device. And so the user's need of finding interesting contents can be satisfied.

The sequence of the aforementioned embodiments of the present disclosure is for description only and does not represent the merits of the embodiments.

Those of ordinary skill in the art may understand that the implementation of all or some of the steps of the aforementioned embodiments may be completed by hardware and may also be completed by programs commanding corresponding hardware. Said programs may be stored in a computer-readable memory medium. The memory medium mentioned above may be a read-only memory, disk, CD, etc.

The aforementioned are merely better embodiments of the present disclosure and shall not restrict the present disclosure. As long as they are within the spirit and principle of the present disclosure, all modifications, equivalent replacements and improvements shall be included in the protection scope of the present disclosure.

1. The method for generating a navigation web page displayed in a web browser, the method comprising:
analyzing web browsing history of the web browser, wherein the web browsing history comprises references to web sites;
based on the analysis generating the navigation web page wherein the navigation web page comprises references to web sites from the web browsing history; and
displaying the navigation web page in the web browser.

2. The method of claim 1 wherein the navigation web page comprises a plurality of categories.

3. The method of claim 2 wherein analyzing the web browsing history comprises analyzing the web sites corresponding to the references to web sites.

4. The method of claim 3 wherein analyzing the web sites comprises performing a textual analysis of content of the web sites.

5. The method of claim 3 wherein based on the analysis of a web site classifying the web as belonging to one of the plurality of categories.

6. The method for updating a navigation web page displayed in a web browser, the method comprising:
analyzing web browsing history of the web browser, wherein the web browsing history comprises references to web sites;
based on the analysis classifying each of the web sites as belonging to a respective one of a plurality of categories;
updating the navigation web page based on the analysis wherein updating the navigation web page comprises adding to the navigation web page references to web sites from the web browsing history; and
displaying the navigation web page in the web browser.

7. The method of claim 6 wherein analyzing web browsing history comprises analyzing each of references of the web sites based on the respective content of the web sites.

8. The method of claim 7 further comprising calculating a respective weight for each of the plurality of categories wherein calculating the respective weight is based on a number of page views of web sites classified as belonging to the respective one of the plurality of categories.

9. The method of claim 8 wherein updating the navigation web page is based on the calculated weight for each of the plurality of web sites.

10. A device for generating a personalized navigation webpage comprising:
acquisition module configured to acquire the categories of interest which already exist and the behavior record of the user in a web browser, and based on the categories of interest which have already existed and the behavior record of the user in the web browser, the information of the user's interest is acquired; and/or acquire the characteristic information of the user's device;
analysis module configured to analyze the information of the user's interest and/or the characteristic information of the user's device;
generation module configured to, based on the result produced by the analysis module above, perform a matching to one of the categories of interest, and generate a personalized navigation webpage in the web browser.

11. The device of claim 10, wherein the acquisition module comprises:
acquisition unit configured to acquire the categories of interest and the behavior record of the user in the web browser;
category unit configured to classify the behavior record of the user into one of the categories of interest; and
calculation unit configured to calculate a respective weight for each of categories of interest.

12. The device of claim 11 wherein the category unit is configured to perform a textual analysis on content of webpages visited by the user.
